(19) United States
(12) Patent Application Publication
(10) Pub. No.: US 2025/0168588 A1
(43) Pub. Date: May 22, 2025

(54) METHOD AND SYSTEM FOR ENHANCING AUDIO FIDELITY IN A VIRTUAL TELECONFERENCING ENVIRONMENT

(71) Applicant: Varjo Technologies Oy, Helsinki (FI)

(72) Inventor: Jelle van Mourik, Barcelona (ES)

(73) Assignee: Varjo Technologies Oy, Helsinki (FI)

(21) Appl. No.: 18/516,063

(22) Filed: Nov. 21, 2023

(51) Int. Cl. H04S 7/00; H04L 65/403; H04R 5/027; H04R 5/033

(52) U.S. Cl. CPC H04S 7/306; H04R 5/027; H04R 5/033; H04L 65/403; H04S 2400/15

(57) ABSTRACT

Disclosed is a method for enhancing audio fidelity in a virtual teleconferencing environment including recording a first audio signal from a first room; performing room impulse response (RIR) analysis for the first room to determine at least one of a direct sound component, an early reflections component and a late reverberation component; extracting at least the late reverberation component from the determined RIR components; recording a second audio signal from a second room; de-reverberating the second audio signal and convolving the de-reverberated second audio signal with at least the late reverberation component to form a third audio signal. Playing the third audio signal in the first room and abstaining from playing in the second room. The virtual teleconferencing environment is generated based on the first room to act as an audio source for the second audio signal.

### TECHNICAL FIELD

The present disclosure relates to methods for enhancing audio fidelity in a virtual teleconferencing environment. The present disclosure also relates to systems for enhancing audio fidelity in a virtual teleconferencing environment.

### BACKGROUND

With advancements in evolving technologies such as immersive extended-reality (XR) technologies, the demand for creating a realistic and immersive XR audio experience has been increasing. While creating a visual experience for a user in an XR environment is a critical aspect, sound plays an equally essential role in delivering an immersive and believable experience for the user in the XR environment and in complementing said visual experience. The presence of high-quality sounds in the XR environment is important for guiding the user's attention and enhancing the emotional engagement of the user in the XR environment.

However, existing systems and techniques for creating the XR audio experience are associated with several limitations. Some existing systems and techniques naively utilize as-it-is recording of a sound collected from the perspective of a user present in an XR environment for other users present in the same XR environment, irrespective of different positions of the other users in the XR environment. In such a case, spatial information of the sound present in the recording is lost, and the other users do not perceive a location, a directionality, and a movement of the sound in the XR environment. As a result, the audio and viewing experiences of other users become highly unrealistic and non-immersive. Therefore, in light of the foregoing discussion, there exists a need to overcome the aforementioned drawbacks associated with existing equipment and techniques for creating an XR audio experience.

### SUMMARY

The aim of the present disclosure is to provide a method and a system for enhancing audio fidelity in a virtual teleconferencing environment. The aim of the present disclosure is achieved by a method and a system for enhancing the audio fidelity in the virtual teleconferencing environment with an improved spatial audio representation by reconstructing an AR teleconferencing. Therefore, the method and the system of the present disclosure aims at improving the perception of the users within a shared augmented reality (AR) teleconferencing environment, as defined in the appended independent claims to which reference is made. Advantageous features are set out in the appended dependent claims.

Throughout the description and claims of this specification, the words “comprise”, “include”, “have”, and “contain” and variations of these words, for example, “comprising” and “comprises”, mean “including but not limited to”, and do not exclude other components, items, integers, or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates steps of a method for enhancing audio fidelity in a virtual teleconferencing environment, in accordance with an embodiment of the present disclosure;

FIG. 2 is an illustration of a block diagram of an architecture of a system for enhancing audio fidelity in a virtual teleconferencing environment, in accordance with an embodiment of the present disclosure;

FIG. 3 is an illustration of an exemplary sequence diagram for enhancing audio fidelity in a virtual teleconferencing environment, in accordance with an embodiment of the present disclosure; and

FIG. 4 is a graphical illustration depicting the behaviour of the sound, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, an embodiment of the present disclosure provides a method for enhancing audio fidelity in a virtual teleconferencing environment, the method comprising:
recording a first audio signal from a first room;
performing room impulse response (RIR) analysis for the first room using the first audio signal to determine at least one of a direct sound component, an early reflections component and a late reverberation component;
extracting at least the late reverberation component from the determined RIR components;
recording a second audio signal from a second room physically spaced apart from the first room;
de-reverberating the second audio signal to remove reverberation from the second audio signal;
convolving the de-reverberated second audio signal with at least the late reverberation component of the first audio signal to form a third audio signal, wherein the third audio signal enhances audio fidelity of the second audio signal by replicating acoustic characteristics of the first room, and
playing the third audio signal in the first room and abstain playing in the second room, wherein the virtual teleconferencing environment is generated based on the first room to act as an audio source for the second audio signal.

In a second aspect, an embodiment of the present disclosure provides a system for enhancing audio fidelity in a virtual teleconferencing environment, the system comprising:
a plurality of headset associated with a plurality of rooms; and
a processor communicably coupled to the plurality of headset, the processor configured to:
   receive a first audio signal recorded by a first headset of the plurality of headset, the first headset associated with a first room;
   perform room impulse response (RIR) analysis for the first room using the first audio signal to determine at least one of a direct sound component, an early reflections component and a late reverberation component;
   extract at least the late reverberation component from the determined RIR components;
   receive a second audio signal recorded by a second headset of the plurality of headset, the second headset associated with a second room physically spaced apart from the first room,
   de-reverberate the second audio signal to remove reverberation from the second audio signal;
   convolve the de-reverberated second audio signal with at least the late reverberation component of the first audio signal to form a third audio signal, wherein the third audio signal enhances audio fidelity of the second audio signal by replicating acoustic characteristics of the first room, and
   play the third audio signal in the first room and abstain from playing in the second room, wherein the virtual teleconferencing environment is generated based on the first room to act as an audio source for the second audio signal.

The present disclosure provides the aforementioned system and the aforementioned method for enhancing the audio fidelity in a virtual teleconferencing environment. The recording and extraction of the at least late reverberation component from the first audio signal from the determined RIR components are used to capture the acoustic ambience of the first room with an enhanced accuracy and reliability. Furthermore, the convolution of the de-reverberated second audio signal with at least the late reverberation component of the first audio signal to form a third audio signal is used to realistically mimic the acoustic qualities of the first room, thereby providing an improved immersive virtual teleconferencing experience to the user. Moreover, the replication of acoustic characteristics, especially late reverberation, adds a layer of realism, making the users in the second room feel as if the corresponding users are physically present in the first room. Moreover, the utilization of RIR analysis allows the aforementioned system and the aforementioned method to provide a comprehensive understanding of the acoustic components in the first room accurately and reliably by avoiding unnecessary elements while ensuring synchronization and coherence. As a result, the aforementioned system and the aforementioned method are used to provide a highly realistic and immersive audio experience in virtual teleconferencing environments, leading to improved audio fidelity and a more authentic communication atmosphere for the user. In addition, the enhancement the overall quality of the virtual teleconferencing environment is achieved without using any room acoustic simulation methods (e.g., image source method (ISM), ray tracing and the like methods) that further reduces the computational complexity and the overall processing time. This, in turn, leads to a significant enhancement in the overall quality of the extended reality encounter.

Throughout the present disclosure, the term “audio fidelity” refers to the reconstruction of audio by maintaining the integrity, accuracy, and reliability of the sound to ensure that the reconstructed audio closely resembles with the original sound. In this regard, the term “virtual teleconferencing environment” refers to a computer-generated environment that allows the users to meet and interact virtually to facilitate remote discussions, collaborations, and information sharing as if they were physically present. For example, a user wearing a headset can see his/her virtual representation along with the virtual representation of the other users that are currently present in the virtual teleconferencing environment, thereby allowing the users to share documents, 3D models, and spatialized audio. Such a virtual teleconferencing environment allows an enhanced engagement and interaction of the users with an enhanced immersive and effective teleconferencing experience.

Throughout the present disclosure, the term “first audio signal” refers to an electrical signal that represents a sound in the real-world environment that is captured within the first room. The aforesaid recording of the first signal is generally performed by microphones or audio recording devices that are arranged inside the headset. Moreover, the recording of the first audio signal from the first room includes any sounds, speech, or ambient noise present in the first room. The technical effect of recording the first audio signal from the first room is used to analyze the acoustic characteristics, for example, real-time room impulse response estimation that improves the overall audio fidelity of the virtual teleconferencing environment, thereby creating an enhanced immersive user experience. Optionally, the first audio signal is associated with acoustic presence and absence in the first room.

In this regard, the term “acoustic presence and absence” refers to the presence and absence of the first audio signal (i.e., the presence and absence of the voice). In an implementation, the first audio signal is associated with the acoustic presence (i.e., the voice) in the first room. In another implementation, the first audio signal is associated with the acoustic absence (i.e., the voice) in the first room. The first audio signal with acoustic presence and absence is further used to analyze the dynamics of the virtual teleconferencing environment, for example, in distinguishing between speech and background noise. That is further used to improve the accuracy of spatial audio representation to the user.

Optionally, recording the first audio signal is performed using one or more microphones.

Throughout the present disclosure, the term “microphone” refers to a specialized equipment that is capable of sensing and converting the sounds in the real-world environment into the first audio signal. It will be appreciated that the sounds in the real-world environment are generated by at least one sound source present in the real-world environment. The at least one sound source could be located in the vicinity of the plurality of microphones or be located at a considerable distance from the plurality of microphones, in the first room. In an implementation, recording the first audio signal is performed using one microphone. In another implementation, recording the first audio signal is performed using two microphones. Optionally, the plurality of microphones are arranged (namely, mounted) on a device present in the first room. In some implementations, said device is arranged at a fixed location within the first room. In such implementation, the said device is stationary within the first room. In other implementations, the said device is a wearable device being worn by a given user present in the first room. In such implementations, the location of said device (and, therefore, the location of a given microphone arranged on said device) changes with a change in the location of the given user. As an example, the device could be arranged on a support structure that is capable of a three-dimensional (3D) rotation (and, additionally, capable of a translation motion). The support structure could be moved to any required location in the first room. Beneficially, in this case, the given microphone (arranged on said device) is movable in the first room to be able to capture the sounds of the user from different positions and/or different directions in the first room.

Examples of the device include, but are not limited to, a head-mounted display (HMD) apparatus. The term “head-mounted display” apparatus refers to a specialized equipment that is configured to present an extended-reality (XR) environment to a given user when said HMD apparatus, in operation, is worn by the given user on his/her head. The HMD apparatus is implemented, for example, as an XR headset, a pair of XR glasses, and the like, that is operable to display a scene of the XR environment to the given user. The term “extended-reality” encompasses virtual reality (VR), augmented reality (AR), mixed reality (MR), and the like.

Throughout the present disclosure, the term “room impulse response (RIR) analysis” refers to the analysis of various characteristics that are used to distinguish and identify the at least one of the direct sound component, early reflections component, and late reverberation component of the recorded first audio signal in the first room. For example, the user speaks in the first room. In that case, the RIR analysis is performed to determine the direct sound, which is the voice of the user, along with the subsequent reflections and the late reverberation as the sound bounces around the first room. The direct sound component provides information about the initial sound source, early reflections help define the room's geometry, and late reverberation contributes to a sense of space. Therefore, the technical effect of performing RIR analysis for the first room using the first audio signal to determine at least one of a direct sound component, an early reflections component and a late reverberation component is used to distinguish between different aspects of the acoustic response that can be further used to recreate an enhanced, accurate, and immersive virtual teleconferencing environment. As a result, the overall quality of the audio experience in applications like virtual teleconferencing is enhanced.

Optionally, performing RIR analysis comprises a plurality of RIR analyses performed in real-time and in a periodic manner to periodically update the determined direct sound component, early reflections component and late reverberation component.

The plurality of RIR analyses are performed continuously in real-time and in a periodic manner to update the determined direct sound component, early reflections component and late reverberation component to account for dynamic changes in the virtual teleconferencing environment. The technical effect of performing RIR analysis comprises a plurality of RIR analyses performed in real-time and in a periodic manner to provide users with a consistently realistic and immersive audio experience, particularly in applications like virtual teleconferencing.

Optionally, performing RIR analysis comprises a plurality of RIR analyses performed in real-time to collate RIR component measurements for determining the direct sound component, the early reflections component and the late reverberation component therefrom.

In this regard, the term “plurality of RIR analyses” includes conducting multiple analyses in real-time, creating a series of measurements for various components such as the direct sound, early reflections, and late reverberation. The plurality of RIR analyses is performed to collect a set of components for different RIR components, such as the direct sound component, the early reflections component, and the late reverberation component, that are further collated to comprehensively understand the acoustic characteristics of the first room in a continuous manner. Thus, the acoustic characteristics that may change rapidly due to the movement of the users, changes in furniture arrangement, or other dynamic factors can be recorded. Therefore, the technical effect of performing the plurality of RIR analyses in real-time is to gain a more nuanced understanding of the direct sound, early reflections, and late reverberation components that can be further used to provide a responsive and accurate spatial audio representation, ensuring that virtual teleconferencing environments deliver a realistic and immersive auditory experience that adapts to changes in the first room.

Throughout the present disclosure, the term “at least the late reverberation component” refers to the sustained echoes or reflections of sound that persist in the virtual teleconferencing environment after the initial direct sound and early reflections. For example, the user speaks in the first room, and then, in that case, the sound interacts with surfaces such as walls, ceilings, and floors, creating reflections that contribute to the overall reverberation. The at least the late reverberation component is extracted to create a realistic and immersive audio experience, such as by adding a depth and a sense of spatial presence to the sound, contributing to the perception of being in the physical environment of the first room to the other users. The technical effect of extracting the at least the late reverberation component is used to manipulate and reproduce the acoustic response, thereby providing an enhanced authentic virtual representation of the virtual environment, especially in applications like virtual teleconferencing, where a natural and immersive audio experience enhances the overall quality of communication.

Furthermore, the recording of the second audio signal from the second room physically spaced apart from the first room includes the recording of the second audio signal (i.e., the audio present in the second room) that is present in the second room. In an implementation, one or more microphones can be placed in the second room to record the second audio signal. Moreover, the second room is physically separated or is located at a certain distance from the first room. The second audio signal is recorded to gather audio data from the second room that can be used for a comprehensive understanding of multiple acoustic environments. The technical effect of recording the second audio signal from the second room, which is physically separated from the first room, facilitates the realistic spatial audio, contributing to an immersive experience, particularly in applications where users may be virtually present in different rooms or locations simultaneously.

Throughout the present disclosure, the term “de-reverberating the second audio signal” refers to a process of removing the reverberation (i.e., echoes or sound reflections) from the recorded second audio signal in the second room in order to obtain a clear and direct representation of the original audio by minimizing the impact of the acoustics of the second room. The technical effect of de-reverberating the second audio signal is to distinguish and separate the direct sound from the reverberant components in the second audio signal to provide an improved precise and clear sound reproduction of the corresponding user who is physically present in the second room.

Throughout the present disclosure, the term “convolving the de-reverberated second audio signal” refers to a mathematical operation that blends the characteristics of the de-reverberated second signal with the late reverberation component from the first signal to form a third audio signal. In this regard, the term “third audio signal” refers to an electrical signal that represents a sound in the real-world environment that is formed to enhance the audio fidelity of the second audio signal by replicating the acoustic characteristics of the first room. Such convolution is used to replicate the acoustic characteristics of the first room in the second room. By introducing the late reverberation component from the first room, the third audio signal enhances the audio fidelity of the second audio signal, making it sound as if it were recorded in the first room. In an implementation, a spatialising technique can be used to enhance the perception of the audio, such as by allowing the convolution with head-related transfer functions that allows an enhanced immersive and realistic experience. The head-related transfer functions are used to determine the way sound interacts with the human head and ears. These head-related transfer functions required to mimic the natural cues of the ears to locate the sound source. The technical effect of convolving the de-reverberated second audio signal with at least the late reverberation component of the first audio signal to form a third audio signal is to provide an enhanced immersive and realistic audio experience, especially in applications like virtual teleconferencing, such as by capturing the essence of the original acoustic environment, providing enhanced audio fidelity in the second room.

Furthermore, playing the third audio signal in the first room and abstaining from playing in the second room refers to the broadcasting of the synthesized audio, which combines the de-reverberated second audio signal with the late reverberation from the first room within the physical space of the first room. Moreover, the virtual teleconferencing environment is generated based on the first room to act as an audio source for the second audio signal. By playing the enhanced audio in the first room, users in that physical space experience the synthesized sound as if it were originating from the physical environment of the second room. The technical effect of abstaining from playing the audio in the second room is used to ensure that the user in different physical locations experiences an audio environment consistent with the acoustics of the first room, contributing to a cohesive and natural teleconferencing experience.

Optionally, the method further comprising
extracting the early reflections component from the determined RIR components and
convolving the de-reverberated second audio signal with the early reflections component of the first audio signal to form the third audio signal.

In this regard, the term “early reflections component” refers to initial sound reflections that occur shortly after the direct sound, typically bouncing off surfaces in the physical environment. For example, in the second room with reflective surfaces, the early reflections component includes the initial reflections of a sound, such as a handclap, as it bounces off walls, ceilings, and floors. The extraction of the early reflections component provides a separate representation of the initial reflections, which can be used to enhance specific aspects of the audio experience. The technical effect of extracting the early reflections component from the determined RIR components and convolving the de-reverberated second audio signal with the early reflections component of the first audio signal to form the third audio signal is used to enhance spatial realism and contribute to a more immersive virtual audio experience, particularly in applications like virtual teleconferencing.

The present disclosure also relates to the method as described above. Various embodiments and variants disclosed above, with respect to the aforementioned system, apply mutatis mutandis to the method.

In this regard, the term “processor” refers to a processor that is configured to control an overall operation of the plurality of headsets and to implement the processing steps. Examples of implementation of the processor may include, but are not limited to, a central data processing device, a microprocessor, a microcontroller, a complex instruction set computing (CISC) processor, an application-specific integrated circuit (ASIC) processor, a reduced instruction set (RISC) processor, a very long instruction word (VLIW) processor, a state machine, and other processors or control circuitry. The processor is communicably coupled to the plurality of headset.

Optionally, the first audio signal is associated with acoustic presence and absence in the first room.

Optionally, each of the plurality of headsets comprises one or more microphones, wherein the first audio signal is recorded using the one or more microphones of the first headset.

Optionally, the processor is configured to perform a plurality of RIR analyses in real-time and in a periodic manner to periodically update the determined direct sound component, early reflections component and late reverberation component.

Optionally, the processor is configured to perform a plurality of RIR analyses in real time to collate RIR component measurements for determining the direct sound component, early reflections component and late reverberation component.

Optionally, the processor is further configured to
extract the early reflections component from the determined RIR components, and
convolve the de-reverberated second audio signal with the early reflections component of the first audio signal to form the third audio signal.

### DETAILED DESCRIPTION OF THE DRAWINGS

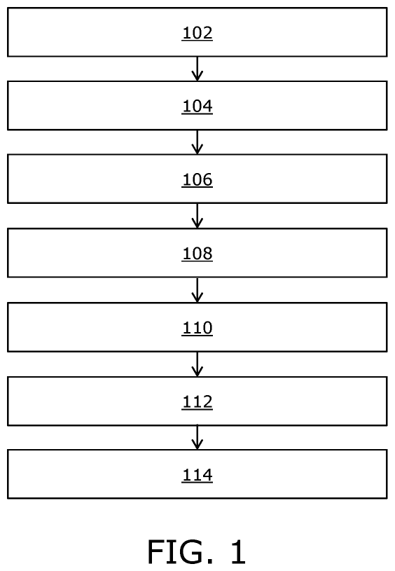

Referring to FIG. 1, illustrated are steps of a method for enhancing audio fidelity in a virtual teleconferencing environment, in accordance with an embodiment of the present disclosure. At step 102, a first audio signal is recorded from a first room. At step 104, a room impulse response (RIR) analysis is performed for the first room using the first audio signal to determine at least one of a direct sound component, an early reflections component and a late reverberation component. At step 106, at least the late reverberation component is extracted from the determined RIR component. At step 108, a second audio signal is recorded from a second room physically spaced apart from the first room. At step 110, the second audio signal is de-reverberated to remove reverberation from the second audio signal. At step 112, the de-reverberated second audio signal is convolved with at least the late reverberation component of the first audio signal to form a third audio signal. Moreover, the third audio signal enhances the audio fidelity of the second audio signal by replicating the acoustic characteristics of the first room. At step 114, the third audio signal is played in the first room and abstain from playing in the second room. Moreover, the virtual teleconferencing environment is generated based on the first room to act as an audio source for the second audio signal.

The aforementioned steps are only illustrative, and other alternatives can also be provided where one or more steps are added, one or more steps are removed, or one or more steps are provided in a different sequence without departing from the scope of the claims.

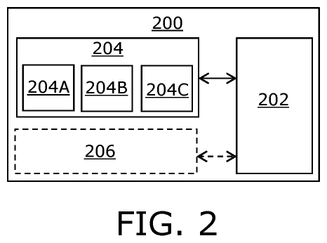

Referring to FIG. 2, illustrated is a block diagram of an architecture of a system 200 for enhancing audio fidelity in a virtual teleconferencing environment, in accordance with an embodiment of the present disclosure. The system 200 comprises a processor 202. The processor 202 is communicably coupled to a plurality of headset 204 (for example, in this case, depicted as headset 204A, 204B, and 204C). The processor 202 is configured to perform various operations, as described earlier, with respect to the aforementioned first aspect.

It may be understood by a person skilled in the art that FIG. 2 includes a simplified architecture of the system 200 for the sake of brevity and clarity, which should not unduly limit the scope of the claims herein. It is to be understood that the specific implementation of the system 200 is provided as an example and is not to be construed as limiting it to specific numbers or types of servers, display apparatuses, and congestion control network devices. The person skilled in the art will recognize many variations, alternatives, and modifications of embodiments of the present disclosure.

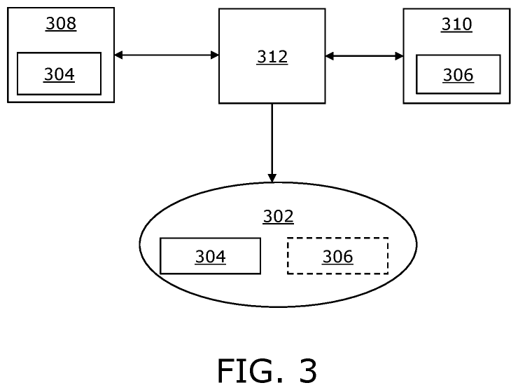

Referring to FIG. 3, illustrated is an exemplary diagram for enhancing audio fidelity in a virtual teleconferencing environment, in accordance with an embodiment of the present disclosure. In FIG. 3, there is shown an illustration that includes a virtual teleconferencing environment 302, a first headset 304, a second headset 306, a first room 308, a second room 310, and a processor 312.

In an implementation, a first user is physically present in the first room 308, and a second user is present physically in the second room 310. Moreover, both the users, that is, the first user and the second user, are wearing headsets. For example, the first user is wearing the first headset 304, and the second user is wearing the second headset 306. The first audio signal is recorded from the first room 308, which includes the recording of the audio from the first user, both when speaking and when silent. Optionally, one or more microphones are configured to record the audio of the first user. Furthermore, the RIR analysis is performed in real-time for the first room 308 to determine at least one of a direct sound component, an early reflections component and a late reverberation component. Furthermore, the at least the late reverberation component is extracted from the determined RIR components and further, a second audio signal from the second room 310 is recorded, such as through the second headset 306. In addition, the second room 310 is physically spaced apart from the first room 308. Thereafter, the second audio signal from the second room 310 is recorded, and later the second audio signal is de-reverberated to remove reverberation from the signal audio signal. After the de-reverberation of the second audio signal, the second audio signal is convoluted with at least the late reverberation component of the first audio signal to form a third audio signal. Moreover, the third audio signal enhances the audio fidelity of the second audio signal by replicating the acoustic characteristics of the first room 308. After that, the third audio signal in the first room and abstain playing in the second room is played to all the users that are present in the virtual teleconferencing environment. As a result, a highly realistic and immersive audio experience in virtual teleconferencing environments with an improved audio fidelity and a more authentic communication atmosphere is provided to the user.

FIG. 3 is merely an example, which should not unduly limit the scope of the claims herein. A person skilled in the art will recognize many variations, alternatives, and modifications of embodiments of the present disclosure.

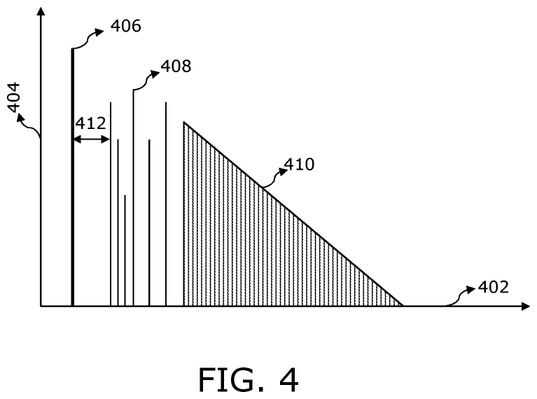

Referring to FIG. 4, illustrated is a graphical illustration depicting the behaviour of the sound, in accordance with an embodiment of the present disclosure. In FIG. 4, there is shown an illustration that includes a time axis 402 that represents how the sound evolves from the direct sound through the early reflections and into the reverberation tail and an amplitude axis 404, which is measured in decibels (db).

In an exemplary scenario, the graph represents a direct sound component 406, early reflections component 408, and the late reverberation component 410. Moreover, the first line represents the direct sound component 406, which represents that the sound travels in a straight line from the source to the listener without any reflections. Furthermore, the lines that follow the direct sound represent the early reflections component 408. The early reflections component 408 represent the sounds that have bounced off surfaces like walls, ceilings, or objects and then reached the listener. The early reflections component 408 are generated immediately after the direct sound component 406 and can greatly affect the perceived character of the sound. An initial time delay 412 represents the gap between the direct sound component 406 and the first reflection, which is used to determine the size of the room and the sense of distance to the sound source. Furthermore, the late reverberation component 410 are generated, represented by the shaded triangle, and extend over time.

After the early reflections component 408, sound waves continue to reflect off surfaces and scatter around the room, which causes the series of reflections to merge into a continuous decay. The late reverberation component 410 diminishes gradually as the sound energy is absorbed by the room surfaces and the air. As a result, the components are performed RIR analysis for the first room using the first audio signal to determine at least one of the direct sound component 406, the early reflections component 408 and a late reverberation component 410 for enhancing audio fidelity in a virtual teleconferencing environment.

FIG. 4 is merely an example, which should not unduly limit the scope of the claims herein. A person skilled in the art will recognize many variations, alternatives, and modifications of embodiments of the present disclosure.

1. A method for enhancing audio fidelity in a virtual teleconferencing environment, the method comprising:
recording a first audio signal from a first room;
performing room impulse response analysis for the first room using the first audio signal to determine at least one of a direct sound component, an early reflections component and a late reverberation component;
extracting at least the late reverberation component from the determined RIR components;
recording a second audio signal from a second room physically spaced apart from the first room;
de-reverberating the second audio signal to remove reverberation from the second audio signal;
convolving the de-reverberated second audio signal with at least the late reverberation component of the first audio signal to form a third audio signal, wherein the third audio signal enhances audio fidelity of the second audio signal by replicating acoustic characteristics of the first room, and
playing the third audio signal in the first room and abstain playing in the second room, wherein the virtual teleconferencing environment is generated based on the first room to act as an audio source for the second audio signal.

2. A method according to claim 1, wherein the first audio signal is associated with acoustic presence and absence in the first room.

3. A method according to claim 1, wherein recording the first audio signal is performed using one or more microphones.

4. A method according to claim 1, wherein performing RIR analysis comprises a plurality of RIR analyses performed in real-time and in a periodic manner to periodically update the determined direct sound component, early reflections component and late reverberation component.

5. A method according to claim 1, wherein performing RIR analysis comprises a plurality of RIR analyses performed in real time to collate RIR component measurements for determining the direct sound component, the early reflections component and the late reverberation component therefrom.

6. A method according to claim 1, further comprising
extracting the early reflections component from the determined RIR components, and
convolving the de-reverberated second audio signal with the early reflections component of the first audio signal to form the third audio signal.

7. A system for enhancing audio fidelity in a virtual teleconferencing environment, the system comprising:
a plurality of headset associated with a plurality of rooms; and
a processor communicably coupled to the plurality of headset, the processor configured to:
receive a first audio signal recorded by a first headset-(of the plurality of headset, the first headset associated with a first room;
perform room impulse response analysis for the first room using the first audio signal to determine at least one of a direct sound component, an early reflections component and a late reverberation component;
extract at least the late reverberation component from the determined RIR components;
receive a second audio signal recorded by a second headset of the plurality of headset, the second headset associated with a second room physically spaced apart from the first room,
de-reverberate the second audio signal to remove reverberation from the second audio signal;
convolve the de-reverberated second audio signal with at least the late reverberation component of the first audio signal to form a third audio signal, wherein the third audio signal enhances audio fidelity of the second audio signal by replicating acoustic characteristics of the first room, and
play the third audio signal in the first room and abstain playing in the second room, wherein the virtual teleconferencing environment is generated based on the first room to act as an audio source for the second audio signal.

8. A system according to claim 7, wherein the first audio signal is associated with acoustic presence and absence in the first room.

9. A system according to claim 7, wherein each of the plurality of headset comprises one or more microphones, and wherein the first audio signal is recorded using the one or more microphones of the first headset.

10. A system according to claim 7, wherein the processor is configured to perform a plurality of RIR analyses in real-time and in a periodic manner to periodically update the determined direct sound component, early reflections component and late reverberation component.

11. A system according to claim 7, wherein the processor is configured to perform a plurality of RIR analyses in real time to collate RIR component measurements for determining the direct sound component, early reflections component and late reverberation component.

12. A system according to claim 7,
wherein the processor is further configured to
extract the early reflections component from the determined RIR components, and
convolve the de-reverberated second audio signal with the early reflections component of the first audio signal to form the third audio signal.
